(19) United States
(12) Patent Application Publication
(10) Pub. No.: US 2024/0095753 A1
(43) Pub. Date: Mar. 21, 2024

(54) SERVICE LEVEL AGREEMENT BUILDER AND MANAGEMENT METHOD AND SYSTEM FOR IMPLEMENTING THE SAME

(71) Applicant: Rakuten Symphony Singapore Pte. Ltd., Singapore (SG)

(72) Inventors: Kuldeep SOLANKI, Madhya Pradesh (IN); Mohit SAHU, Madhya Pradesh (IN)

(21) Appl. No.: 17/639,338

(22) PCT Filed: Jan. 28, 2022
(86) PCT No.: PCT/US2022/014190

§ 371 Date: Aug. 3, 2023

(51) Int. Cl. G06Q 30/018

(52) U.S. Cl. CPC G06Q 30/018

(57) ABSTRACT

A system for managing a service level agreement (SLA) including a non-transitory computer readable medium and a processor. The processor is configured to search a database based on a query, wherein the database contains a plurality of SLA records. The processor is configured to identify, in response to a determination that at least one SLA of the plurality of SLA records matches the query, actions to be taken, wherein each of the actions is defined by the at least one SLA. The processor is configured to determine whether a breach of the at least one SLA occurred based on the identified actions to be taken. The processor is configured to instruct a transmitter to automatically transmit a breach notification to a recipient in response to the determination that the breach of the least one SLA occurred, wherein the recipient is defined by the at least one SLA.

### BACKGROUND

Service level agreements (SLAs) are used to define performance criteria for vendors to customers. SLAs define conditions which constitute a breach of the performance criteria by the vendor and remedies available to the customer based on the resulting breach. SLAs are common in industries such as telecommunications in order to hold a vendor accountable for providing agreed upon levels of service to the customer through a telecommunication network. At any point in time, a company has the possibility of being both a vendor and a customer for different relationships governed by SLAs.

In some instances, a company is party to a large number of SLAs, each of which potentially has different breach and enforcement criteria. Monitoring of the SLAs to determine whether a breach has occurred becomes more difficult and time consuming as the number of SLAs that the company is party to increases. Difficulty in monitoring SLAs further increases as SLAs expire or are completed and other SLAs are implemented.

In some instances, due to unforeseen circumstances, a company seeks to adjust the terms of an SLA. Often, the terms of the SLA are adjusted by terminating a previous SLA and implementing a new SLA, which is a time consuming and difficult task.

A system and method for dynamically generating and managing SLAs would help to reduce or resolve the above issues. Automatic monitoring of the SLA would help to reduce or avoid the risk of failing to promptly identify a breach of the SLA or to identify remedies for a breach.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a flowchart of a method of generating a service level agreement (SLA) in accordance with some embodiments.

FIG. 2 is a flowchart of a method of managing an SLA in accordance with some embodiments.

FIG. 3 is a block diagram of a system for managing an SLA in accordance with some embodiments.

FIG. 4 is a view of a graphical user interface (GUI) usable for managing an SLA in accordance with some embodiments.

FIG. 5 is a view of a GUI for creating an SLA in accordance with some embodiments.

FIG. 6 is a view of a GUI for creating an SLA in accordance with some embodiments.

FIG. 7 is a block diagram of a system for creating or managing an SLA in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Generation and management of service level agreements (SLAs) is a cumbersome process for many companies. In the telecommunication, and other, industries companies are often subject to a large number of SLAs at any point in time, both as a customer and a vendor. Tracking performance and potential breaches of the SLAs is difficult, especially when terms of the SLAs change or outdated SLAs are replaced by new SLAs. Sorting through so many different agreements and determining whether a breach occurred, and the proper remedies reduces the likelihood of actually identifying a breach in a timely manner. This, in turn, means that the remedy sought as a result of an untimely identified breach is no longer available in some instances.

In addition, modification of existing SLAs to account for unforeseen circumstances or changes to a scope of work is difficult and often results in merely discontinuing the existing SLA and implementing a new SLA. This process further exacerbates the difficulty and complexity in monitoring and managing the SLAs for a company by adding new SLAs and determining enforcement periods for the discontinued SLA and the new SLA.

The current description includes a system and method for generating and managing SLAs. The system and method described herein, helps to automatically identify breaches and provides notifications to customers upon breach by the vendor. The system and method also provide an ability for customers or vendors to generate SLA templates and determine criteria for performance, breach and remedies to reduce the difficult and complexity in managing implementation of the SLAs. The system and method also allow modification of the SLA during implementation to easily adapt the agreement to account for changes in work scope or unforeseen circumstances. The system and method also allow easy deactivation or discontinuation for SLAs which are completed or otherwise terminated, which allows a user to easier identify SLAs that are no longer in force.

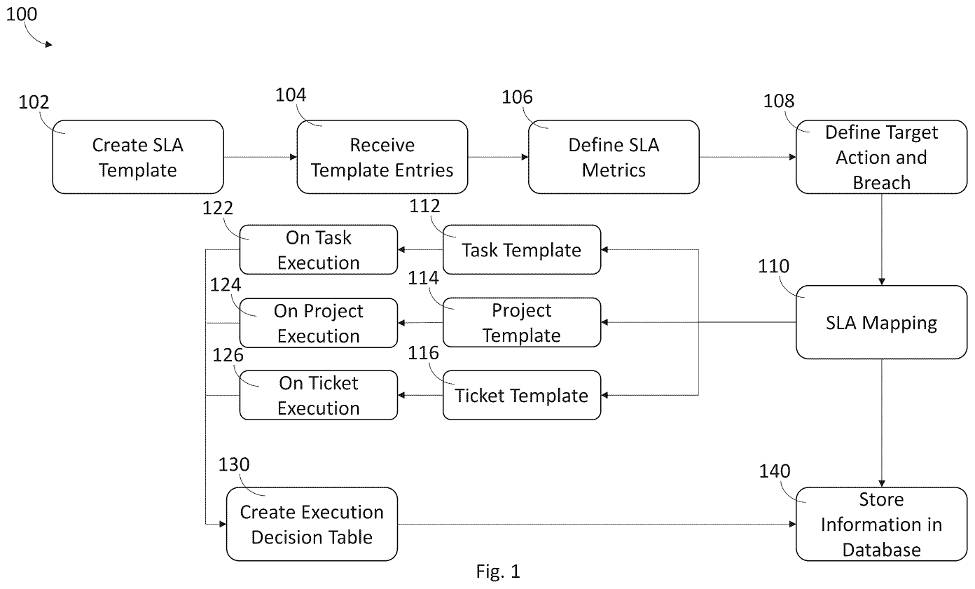

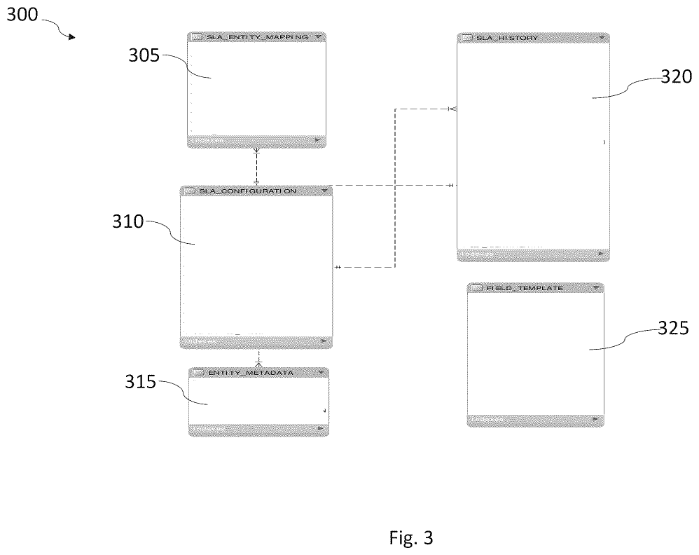

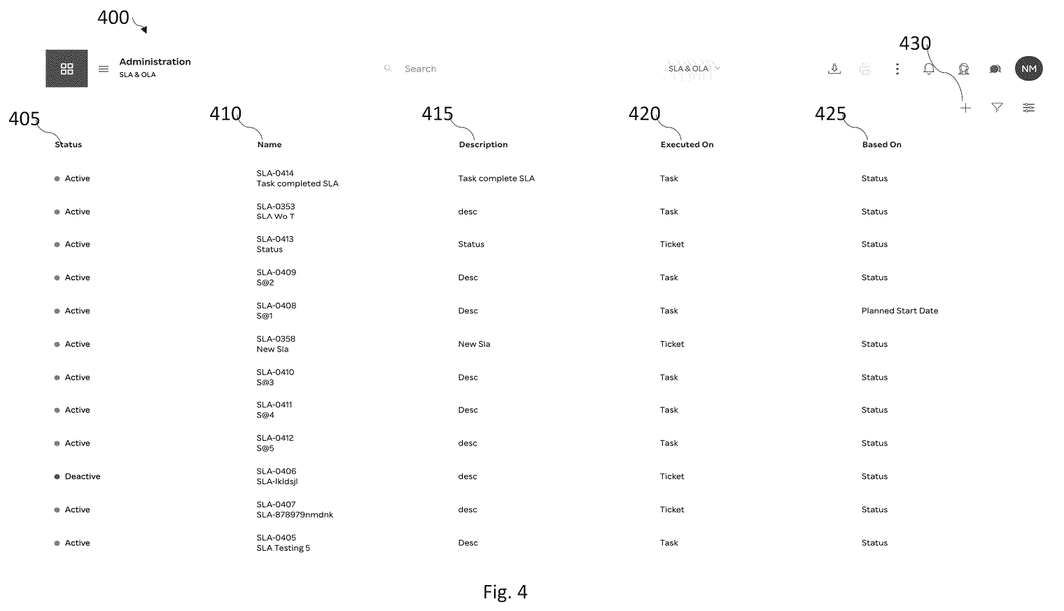

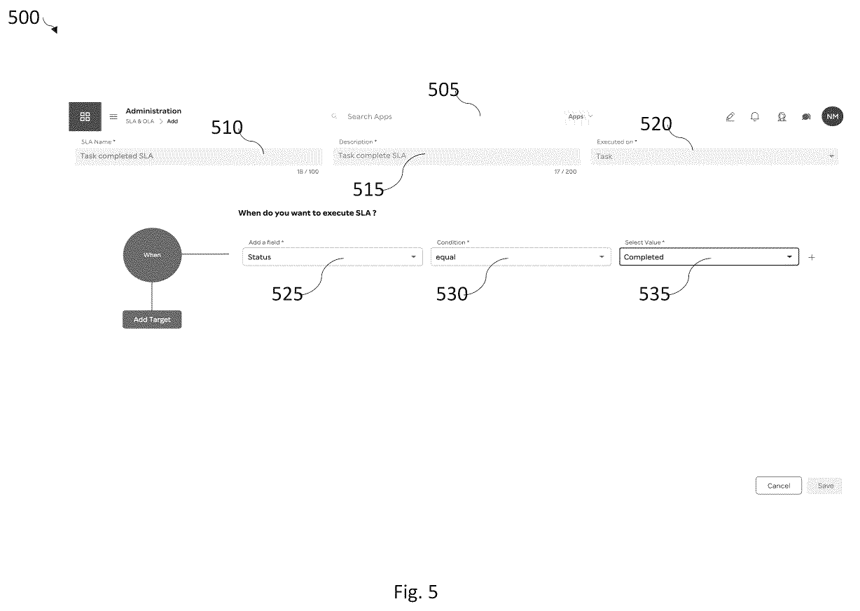

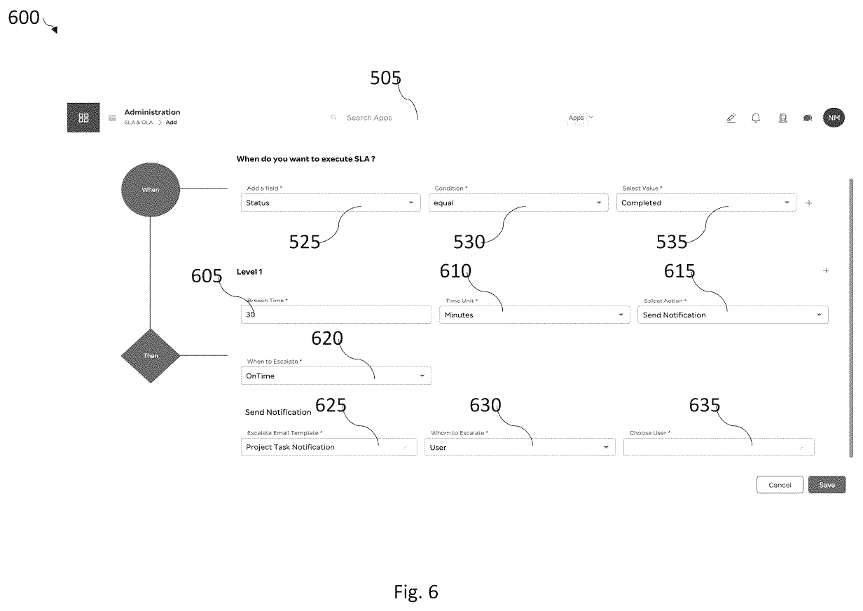

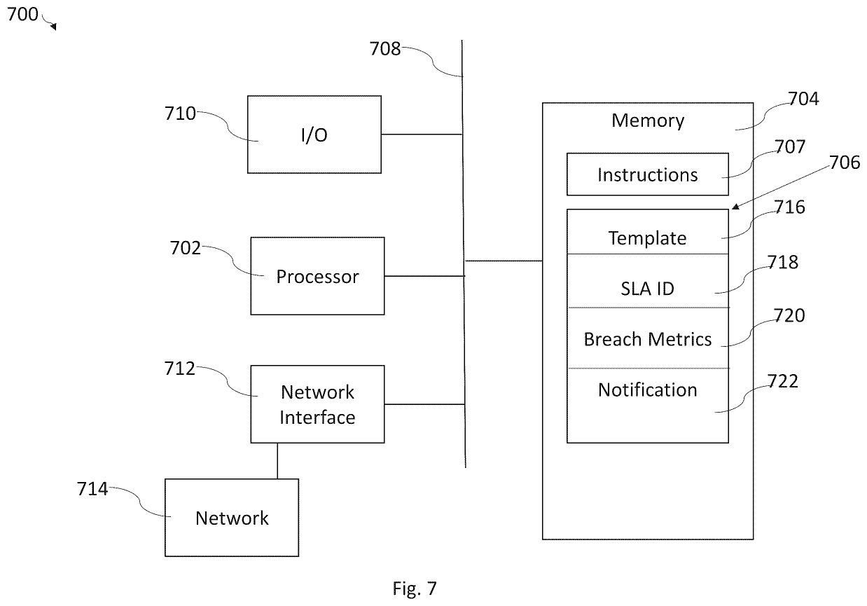

FIG. 1 is a flowchart of a method 100 of generating an SLA in accordance with some embodiments. The method 100 is usable to generate an SLA using an updatable template to determine performance criteria and breach conditions for the SLA. The method 100 is capable of being implemented using a system, e.g., a system 300 (FIG. 3), a system 700 (FIG. 7), or another system. In some embodiments, the method 100 is at least partially implemented using a graphical user interface (GUI), e.g., a GUI 500 (FIG. 5), a GUI 600 (FIG. 6) or another GUI. Once the SLA is generated using the method 100, the SLA is stored in a database and is capable of being displayed in a GUI usable for managing the SLA, e.g., a GUI 400 (FIG. 4) or another GUI.

In operation 102, an SLA template is created. In some embodiments, the SLA template is imported from a separate system. In some embodiments, the SLA template is created in a system used to implement the method 100. In some embodiments, the SLA template is created using a GUI. In some embodiments, more than one SLA template is created. The SLA template includes fillable fields for receiving information related to defining a name of an SLA, objectives, performance requirements, breach conditions and remedies to define a specific SLA. In some embodiments, the SLA template further includes information related to projects, tasks and ticket items to be completed as part of the SLA.

In operation 104, template entries are received. The template entries include SLA specific details in order to define the name, objective, performance requirements, breach conditions, and remedies for the SLA. In some embodiments, the template entries are received through a GUI, such as GUI 500 (FIG. 5), GUI 600 (FIG. 6), or another GUI. In some embodiments, the template entries are automatically filled with default entries based on predetermined preferences of a customer or vendor. The default entries are then editable to adjust the features of the SLA. In some embodiments where the SLA is being modified from a pre-existing or currently in force SLA, the template entries are automatically populated with the terms of the pre-existing or currently in force SLA to allow easy modification of only the features desired to be adjusted in the new SLA. The template entries also include receiving contact information for notification in response to a breach of the SLA.

In operation 106, metrics for performance of the SLA are defined. The metrics for performance are defined based on the template entries received in operation 104. In some embodiments, the metrics are received ugh a GUI, such as GUI 500 (FIG. 5), GUI 600 (FIG. 6), or another GUI. In some embodiments, the metrics are calculated based on the template entries received in operation 104. In some embodiments, the metrics are automatically filled with default information based on predetermined preferences of a customer or vendor. The default entries are then editable to adjust the metrics of the SLA. In some embodiments where the SLA is being modified from a pre-existing or currently in force SLA, the metrics are automatically populated with the terms of the pre-existing or currently in force SLA to allow easy modification of only the metrics desired to be adjusted in the new SLA. In some embodiments, the metrics includes information such as resolution time for tickets generated during the SLA. In some embodiments, the resolution time is determined based on a priority status of a ticket generated. For example, in some embodiments, a resolution time for an urgent ticket item is shorter than a resolution time for a minor ticket item.

In operation 108, target actions and breach conditions are defined. The target actions include actions to undertake in response to identification of a breach of the SLA. In some embodiments, the target actions include notification of the customer. The notification of the customer is based on information received in operation 104 in some instances. In some embodiments, the target actions include automatically implementing a remedy based on information received in operation 104. In some embodiments, the target actions include information related to what breach occurred, when a breach occurred and/or remedies available to the customer resulting from the breach.

The breach conditions include the performance criteria the vendor should adhere to in order to avoid breaching of the SLA. In some embodiments, the breach conditions include project definitions, tasks to be completed, or completion time periods for tickets. A task is related to performance of a specific job, such as installation of a piece of equipment at a base station site. A project is made up of multiple tasks, such as upgrading of routers at multiple base station sites. A ticket is an assignment to address an unplanned item, such as an alarm generated by an outage at a base station. The breach conditions would include specific projects, tasks and tickets along with corresponding timing for completion. In some embodiments, the breach conditions include criteria for maintaining of performance, such as coverage quality provided by the network.

In operation 110, SLA mapping is performed. SLA mapping includes aggregation of data related to the SLA template entries. The received information is categorized based on information such as ticket level, task level and project level data. A vendor is then able to assign resources to completion of the various tickets, tasks and projects defined by the SLA template including the data received for the template entries.

In operation 112, task template items are implemented based on vendor resources. The task template includes task items from the SLA template defined based on entries received in operation 104. In some embodiments, a task item includes installation of equipment at a base station site, replacing equipment at a base station site, re-aligning equipment, or other suitable planned performance items.

In operation 114, project template items are implemented based on vendor resources. The project template includes project items from the SLA template defined based on entries received in operation 104. The project template items include multiple tasks. In some embodiments, a project item includes upgrading of routers within a telecommunication network, performance testing across a telecommunication network, or other planned large scale items including multiple tasks for implementation.

In operation 116, ticket template items are implemented based on vendor resources. The ticket template includes ticket items from the SLA template defined based on entries received in operation 104. The ticket items include resolution of unplanned events, such as alarms, that occur during operation of the telecommunication network. In some embodiments, a ticket item includes resetting of equipment, replacing equipment, or other unplanned items resulting from operation of the telecommunication network.

In operation 122, execution of task items from the task template are updated. In some embodiments, the updating of the task items includes providing confirmation of completion of task items. In some embodiments, the updating of the task items includes updating an estimated date or time of completion of the task item. Ins some embodiments, the updating of the task items includes indicating that completion of the task item will fall outside of the breach conditions of the SLA, i.e., a breach has or will occur.

In operation 124, execution of project items from the project template are updated. In some embodiments, the updating of the project items includes providing confirmation of completion of project items. In some embodiments, the updating of the project items includes updating an estimated date or time of completion of the project item. Ins some embodiments, the updating of the project items includes indicating that completion of the project item will fall outside of the breach conditions of the SLA, i.e., a breach has or will occur.

In operation 126, execution of ticket items from the ticket template are updated. In some embodiments, the updating of the ticket items includes providing confirmation of completion of ticket items. In some embodiments, the updating of the ticket items includes updating an estimated date or time of completion of the ticket item. Ins some embodiments, the updating of the ticket items includes indicating that completion of the ticket item will fall outside of the breach conditions of the SLA, i.e., a breach has or will occur.

Separating the mapped SLA into tasks, projects and tickets helps to provide an increase level of granular monitoring of the SLA. Instead of the SLA being monitored or managed as an overall agreement, monitoring of the specific items of the SLA permits easier identification of breaches and corresponding remedies available to the customer. In addition, the vendor is able to easily identify items which are approaching breach conditions in order to determine whether to adjust resource allocation, including adding additional resources, to avoid or reduce future breaches.

In operation 130, an execution decision table is created. The execution decision table groups items to be implemented that have similar conditions for completion. The execution decision table helps to identify overlaps in items to be executed. For example, if a ticket item is to be completed at a specific location and a task item is to be completed at the same specific location, the execution decision table would help to identify a potential overlap at the specific location. This identified potential overlap helps the vendor allocate resources to improve efficiency in completion of the terms of the SLA and reduce or avoid a risk of breaching the SLA. The execution decision table is generated or updated as new information becomes available. For example, a new ticket item resulting from a newly received alarm would add information to be included in the execution decision table. Further, completion or updating of information for an item from operations 122-126 also provides additional information for updating of an execution decision table.

In operation 140, the SLA and execution decision table are stored in a database. The database includes a non-transitory computer readable medium for storing the SLA and the execution decision table. In some embodiments, the database is part of a cloud network. In some embodiments, the database is controlled by the vendor. In some embodiments, the database is controlled by the customer. In some embodiments, the database is controlled by a third-party independent from the vendor and the customer. The vendor and the customer are able to access the database to retrieve the SLA and the execution decision table. In some embodiments, the SLA and/or the execution decision table are updated as the SLA is modified or execution of items from the SLA are updated, such as in operations 122-126.

In some embodiments, the method 100 includes at least one additional operation. For example, in some embodiments, the method 100 further includes an operation of providing a variety of SLA templates to a customer or vendor for selection. In some embodiments, at least one operation from the method 100 is removed. For example, operation 108 is combined with operation 106 and the separate operation 108 is removed. In some embodiments, an order of operations of the method 100 is changed. For examples, in some embodiments, operation 110 is performed after operation 140. One of ordinary skill in the art would recognize that additional modifications to the method 100 are within the scope of this disclosure.

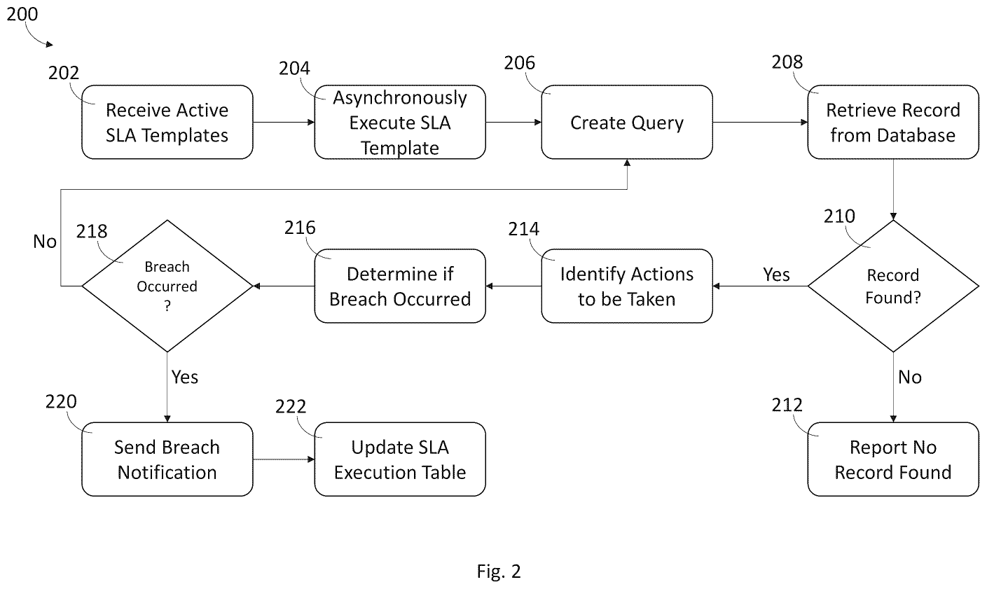

FIG. 2 is a flowchart of a method 200 of managing an SLA in accordance with some embodiments. The method 200 is usable to manage an SLA using to determine performance criteria and breach conditions for the SLA are identified. The method 200 is capable of being implemented using a system, e.g., a system 300 (FIG. 3), a system 700 (FIG. 7), or another system. In some embodiments, the method 200 is at least partially implemented using a GUI, e.g., a GUI 400 (FIG. 4), or another GUI. In some embodiments, the method 200 is implemented using a same system used to implement method 100 (FIG. 1). In some embodiments, the method 200 is implemented using a different system from that used to implement method 100.

In operation 202, active SLA templates are received. In some embodiments, the active SLA templates are received from a database, such as the database used to store SLA templates in operation 140 (FIG. 1). In some embodiments, the database is part of a same system as that used to implement method 200. In some embodiments, the active SLA templates are received from an external device. In some embodiments, the active SLA templates are received wirelessly. In some embodiments, the active SLA templates are received via a wired connection.

In operation 204, the SLA templates are executed in an asynchronous manner. Asynchronous execution means that the SLA templates are managed in method 200 independently of one another. Asynchronous execution also means that the management of the received active SLA templates is performed independent from creation of new SLA templates, e.g., using the method 100 (FIG. 1). Execution of the SLA includes determining whether occurrence of events, such as alarms, time lapse, or other criteria, that trigger actions defined by the SLA.

In operation 206, a query is created. A query includes identification of words for use in the execution of the SLA. The query is generated using a query builder. The query builder allows the manager of the SLA to select criteria for review in the received active SLA templates. In some embodiments, the query relates to vulnerabilities to identify items that should be resolved as quickly as possible. In some embodiments, the query relates to duration since a previous update to identify items that have not been reviewed for a long time. In some embodiments, the query relates to credential review to identify items which are not being fully identified by scan engines. In some embodiments, the query relates to tagged items to determine which items have tags for monitoring. In some embodiments, the query relates to a specific group, such as a customer or a vendor, to identify items related to that group. In some embodiments, different combinations of queries are used in order to more precisely filter the items to be viewed by the SLA manager.

In some embodiments, the query is automatically pulled from a database, such as the database used to store the SLA templates in operation 140 (FIG. 1). In some embodiments, vulnerabilities higher than a predetermined vulnerability threshold are automatically pulled for review. In some embodiments, the predetermined vulnerability threshold is based on an urgency level, e.g., on a range from 1 to 10 with 10 being the most urgent. In some embodiments, the predetermined vulnerability threshold is an urgency value of 8 or more. In some embodiments, the predetermined vulnerability threshold is set by the SLA manager, the SLA customer, or the SLA vendor. In some embodiments, queries related to duration since a previous update are automatically pulled based on a predetermined duration threshold. In some embodiments, the predetermined duration threshold is constant for all types of items in the SLA templates. In some embodiments, the predetermined duration threshold is adjusted based on a vulnerability level of the item. For example, as a vulnerability of the item increases, the corresponding predetermined duration threshold decreases. In some embodiments, the predetermined duration threshold is set by the SLA manager, the SLA customer, or the SLA vendor. One of ordinary skill in the art would recognize that the examples of automatically pulled queries are not limiting and that other queries are also able to be pulled automatically.

In operation 208, records are retrieved from a database based on the queries created in operation 206. In some embodiments, the database is the database used to store the SLA templates and execution decision table in operation 140 (FIG. 1). Using the queries, the database is searched to identify records which match the search parameters defined by the received queries. In some embodiments, the records are displayed using a GUI, such as GUI 400 (FIG. 4).

In operation 210, a determination is made regarding whether any records were identified that match the queries based on the results of operation 208. In response to a determination that no records were found that match the queries, the method 200 proceeds to operation 212. In response to a determination that at least one record was found that matches the queries, the method 200 proceeds to operation 214.

In operation 212, a notification is provided to the SLA manager that no records match the queries. In some embodiments, the notification includes an alert provided to the SLA manager. In some embodiments, the alert includes an audio or visual alert. In some embodiments, the notification includes a display of the query which failed to identify any matching record. In some embodiments, the notification includes an invitation to adjust the query. In some embodiments, in response to a failure to find any active SLA templates matching the query, the method 200 includes searching de-active or proposed SLA templates to determine whether any matching records are able to be identified. In some embodiments, searching for de-active or proposed SLA templates includes limiting the search based on a predetermined time period before or after the search is performed. For example, in some embodiments, the time period is limited to one week before or after the search is performed. In some embodiments, the time period is set by the SLA manager, the SLA customer, or the SLA vendor based on a number of SLA templates within the database. In some embodiments, the operation 212 is omitted and no action is performed in response to a failure to identify any records matching the query.

In operation 214, actions to be taken by the vendor are identified. Determining the actions to be taken includes reviewing the SLA template to identify the vendor obligations with respect to the identified records. In some embodiments, the action includes a ticket item, such as resolution of an alarm. In some embodiments, the action includes a task item, such as installation of equipment. In some embodiments, the action includes a project item, such as replacement of equipment at multiple locations. In some embodiments, identification of the action also includes determination of a time period for completing the identified action.

In operation 216 a determination is made regarding whether the conditions of the identified action were completed. In some embodiments, the determination of whether the conditions were completed includes determining both whether the labor as well as the timeliness of completion fall within the conditions defined in the SLA template. In some embodiments, the method 200 includes generating a reminder for the SLA manager to review the SLA template in response to a determination that a time period for completing the labor has not yet passed. In some embodiments, the reminder includes an audio or visual alert. In some embodiments, the reminder includes a request to schedule automatic generation of a query for the record to be performed in operation 206 following expiration of the time period to complete the labor. In some embodiments, the automatic generation is set in response to receiving confirmation of the request from the SLA manager.

In operation 218, a determination is made regarding whether a breach has occurred. In response to a determination that a breach occurred, the method 200 proceeds to operation 220. In response to a determination that a breach did not occur, the method 200 returns to operation 206.

In operation 220, a breach notification is transmitted to the customer. A recipient of the breach notification is defined by the entries in the SLA template, for example, in operation 104 (FIG. 1). In some embodiments, the breach notification is transmitted to multiple recipients. In some embodiments, the breach notification includes an electronic mail (email). In some embodiments, the breach notification includes an alert transmitted to a mobile device controllable by the recipient. In some embodiments, the alert includes an audio or visual alert. In some embodiments, the alert is configured to automatically appear on a screen of the mobile device without interaction from the recipient. In some embodiments, the breach notification includes information related to the breach. In some embodiments, the information related to the breach includes information about the SLA vendor, information related to a time of the breach, information related to a status of labor performed for the item related to the breach, information related to a contact point within the SLA vendor organization to contact regarding the breach, or other suitable information. In some embodiments, the breach notification includes information related to a remedy available to the SLA customer. In some embodiments, the remedy is automatically applied, and the breach notification includes merely a notification that the remedy has been implemented. In some embodiments, the breach notification informs the recipient of the breach and lists more than one possible remedy determined based on the retrieved SLA template record. In some embodiments, the recipient is able to select which of the possible remedies to receive. In some embodiments, the breach notification is also sent to the SLA vendor. Whether to send the breach notification to the SLA vendor is determined based on the received SLA record.

In operation 222, the SLA execution table in the database is updated. The SLA execution table is updated in the database which contains the retrieved SLA record associated with the breach. In some embodiments, the update to the SLA execution table includes an increase in an importance or urgency level of the item associated with the breach. In some embodiments, the update to the SLA execution table labeling the item in the SLA execution table as being breached, such as attaching a flag to an entry in the SLA execution table.

In some embodiments, the method 200 includes at least one additional operation. For example, in some embodiments, the method 200 further includes an operation of providing a breach notification to the SLA vendor. In some embodiments, at least one operation from the method 200 is removed. For example, operation 212 is omitted and no action is performed in response to failure to identify a record matching the query. In some embodiments, an order of operations of the method 200 is changed. For examples, in some embodiments, operation 222 is performed prior to operation 220. One of ordinary skill in the art would recognize that additional modifications to the method 200 are within the scope of this disclosure.

FIG. 3 is a block diagram of a system 300 for managing an SLA in accordance with some embodiments. In some embodiments, the system 300 is usable to implement one or both of method 100 (FIG. 1) or method 200 (FIG. 2). In some embodiments, the system 300 includes hardware, such as one or more memories and one or more processors, connected to a same server. In some embodiments, the system 300 includes hardware on different servers. In some embodiments, the system 300 includes the system 700 (FIG. 7). In some embodiments, the system 300 is connected to the system 700 (FIG. 7). In some embodiments, the system 300 is usable to produce at least one GUI, such as GUI 400 (FIG. 4), GUI 500 (FIG. 5), GUI 600 (FIG. 6), or another suitable GUI.

The system 300 includes an SLA mapping device 305. The SLA mapping device is configured to store various SLA templates without data entered into fields of the SLA template. In some embodiments, the SLA mapping device 305 is usable to implement operation 102 (FIG. 1). In some embodiments, the SLA mapping device 305 is configured to generate a GUI for receiving entries, such as GUI 500 (FIG. 5), GUI 600 (FIG. 6), or another suitable GUI. In some embodiments, the SLA mapping device 305 includes default information in one or more fields of the SLA templates. In some embodiments, each of the SLA templates in the SLA mapping device 305 includes a name that describes a type of SLA outlined by the SLA template.

The system 300 further includes an SLA configuration device 310. The SLA configuration device 310 is configured receive information to be entered into the SLA template from the SLA mapping device 305. In some embodiments, the SLA configuration device 310 is configured to receive information from GUIs, such as GUI 500 (FIG. 5), GUI 600 (FIG. 6), or another suitable GUI. In some embodiments, the SLA configuration device 310 is configured to identify information in a selected SLA template from the SLA mapping device 305 and identify fields for which information should be received. In some embodiments, the SLA configuration device 310 is configured to work in conjunction with the SLA mapping device 305 in order to generate the GUIs for receiving information.

The system 300 further includes entity information 315. The entity information 315 includes contact information for a recipient to receive a breach notification in response to determining a breach of the SLA has occurred. In some embodiments, the entity information 315 includes a name, contact address, or other information related to identifying a recipient to receive a notification of a breach. In some embodiments, the entity information 315 includes information related to recipient preferences for receiving the breach notification. For example, in some embodiments, the entity information includes information related to a manner in which the breach notification is received, such as email, mobile device alert, text message, or other notification sources. In some embodiments, the entity information 315 includes information related to whether the recipient would like to receive remedy information accompanying a breach notification.

The system 300 further includes an SLA history storage 320. The SLA history storage 320 is configured to store information related to the execution of actions defined by the SLA. In some embodiments, the SLA history storage 320 includes an execution decision table, such as the execution history table generated in operation 130 (FIG. 1) or the execution history table updated in operation 224 (FIG. 2). In some embodiments, the SLA history storage 320 includes information received from the SLA vendor during execution of action items for the SLA, such as information received from any of operations 122-126 (FIG. 1). The information in the SLA history storage 320 is usable to compare with information from the SLA configuration device 310 to determine whether a breach of the SLA has occurred.

The system 300 further includes SLA template field storage 325. The SLA template field storage is configured to store information related to data types and metrics available to create SLA templates, such as the SLA templates used by the SLA mapping device 305. The information in the SLA template field storage 325 is able to be updated in response to addition of new criteria or metrics for consideration in future SLA templates.

FIG. 4 is a view of a GUI 400 usable for managing an SLA in accordance with some embodiments. The GUI 400 is usable as to help manage SLA templates to determine whether any breaches of the managed SLAs have occurred. In some embodiments, the GUI 400 is generated in response to retrieving records from a database, e.g., in operation 208 (FIG. 2), in response to a query. In some embodiments, the GUI 400 is usable by a system, e.g., system 300 (FIG. 3), system 700 (FIG. 7), or another suitable system in order to assist with managing of SLAs. In some embodiments, the GUI 400 is generated based on information received in from a user, e.g., based on information received in operation 104 (FIG. 1).

The GUI 400 includes a table, where each row of the table corresponds to a same SLA. The GUI 400 includes a status column 405 which indicates whether the SLA is in an active state or a deactive state. An active state indicates that the SLA is currently being processed and that less than all labor associated with the SLA is completed. A deactive state indicates that the SLA is not currently in force. For example, in some embodiments, the deactive state indicates that all labor associated with the SLA has been completed, the SLA has been paused (held in suspension), the SLA has been materially breached, or another occurrence which indicates management of the SLA is not currently desired. A material breach is a breach of such significance that the SLA cannot be completed to the satisfaction of the SLA customer. The GUI 400 includes a single SLA in a deactive state. All other SLAs are in an active state. The status column 405 further includes an icon, e.g., red or green, indicating a state of the SLA in order to assist the SLA manager is easy identification of a status of each SLA in the GUI 400.

The GUI 400 further includes a name column 410 which includes a name of the SLA. The name of the SLA includes identifying information to allow the SLA manager to identify the SLA and track criteria and performance of the SLA. In some embodiments, the name includes alpha-numeric characters. In some embodiments, each name in the name column 410 associated with a same vendor has a unique vendor series of alpha-numeric characters. In some embodiments, each name in the name column 410 associated with a same customer has a unique vendor series of alpha-numeric characters. In some embodiments, the name of the SLA to be displayed in the GUI 400 is received in the operation 104 (FIG. 1).

The GUI 400 further includes a description column 415. The description column 415 includes information related to a status of the SLA. For example, in some embodiments, the description includes a most update to the SLA. In some embodiments, the description column 415 includes information indicating that a task is completed. In some embodiments, the task includes identifying information to permit the SLA manager to easily identify which task in the SLA was completed. In some embodiments, the description column 415 includes information indicating that the SLA is a newly implemented SLA and that no labor has begun. In some embodiments, the description column 415 indicates that a status check on the SLA was a most recent update to the SLA.

The GUI 400 further includes an execution column 420. The execution column 420 indicates to which a type of item the most recent update in the description column 415 is related. In some embodiments, the execution column 420 indicates whether the most recent update was related to a ticket item, a task item, or a project item.

The GUI 400 further includes a basis column 425. The basis column 425 indicates a criteria on which performance of the SLA is measured. For example, in some embodiments, the basis column 425 includes “status” indicating that the breach condition for the SLA is determined based on a status of a ticket, task or project. In some embodiments, the basis column 425 includes information such as priority, resolve time or other performance basis criteria for determining whether the SLA is breached.

The GUI 400 further includes an addition icon 430 configured to permit an SLA manager to define a new SLA template. In some embodiments, an SLA customer or an SLA vendor is also able to access the GUI 400 in order to add a new SLA template.

The above description of GUI 400 is not limiting as to the type of information and functionality of the GUI 400. One of ordinary skill in the art would recognize that the GUI 400 includes additional functionality that is not described in detail above. For example, in some embodiments, the GUI 400 includes a searching functionality to receive queries, such as for operation 206 (FIG. 2), and compare the queries with stored SLA records.

FIG. 5 is a view of a GUI 500 for creating an SLA in accordance with some embodiments. The GUI 500 is usable as to help create SLA templates by receiving information to be input into the SLA. In some embodiments, the GUI 500 is generated based on receiving of template entries, e.g., in operation 104 (FIG. 1) or operation 106 (FIG. 1), in response to receiving or creating an SLA template. In some embodiments, the GUI 500 is usable by a system, e.g., system 300 (FIG. 3), system 700 (FIG. 7), or another suitable system in order to assist with creation of SLAs. In some embodiments, the GUI 500 is generated to receive information from a user, e.g., based on information received in operation 104 (FIG. 1) and/or operation 106 (FIG. 1).

The GUI 500 includes a search field 505 configured to receive search terms to allow a user, such as an SLA customer, SLA vendor or SLA manager, to search for SLA templates having desired criteria. The GUI 500 includes a name field 510 configured to receive a same of an SLA. The GUI 500 further includes a description field to describe a target action to be completed by the SLA vendor. The GUI 500 further includes an execution field 520 configured to receive information related to a type of action item to be performed, such as task, ticket, project, etc. In some embodiments, the execution field 520 includes a drop down menu of selectable options. Fields 510-520 provide identifying information for the SLA template. In some embodiments, the fields 510-520 are completed during operation 104 (FIG. 1).

The GUI 500 further includes additional fields that define conditions for the performance of the labor defined in the SLA. The GUI 500 includes a criteria field 525 which indicates a criteria for determining whether a breach occurred. The criteria field 525 is filled with information such as status, priority, resolve time, etc. In some embodiments, the criteria field 525 includes a drop down menu for selectable options. In some embodiments, the selectable options in the criteria field 525 are determined based on information entered in execution filed 520.

The GUI 500 further includes a condition field 530. The condition field 530 indicates a relationship between the information in the criteria field and information in a value field 535 to determine breach. The condition field 530 includes information like equal to, greater than, less than, etc. In some embodiments, the condition field 530 includes a drop-down menu of selectable options.

The GUI 500 further includes the value field 535. The value field 535 includes threshold information for determining a level of work expected to be performed in order to satisfy the SLA criteria. In some embodiments, the value field includes information such as complete, in progress, begin work, or other suitable conditions. In some embodiments, the value field 535 includes a drop down menu of selectable options. By comparing the criteria field 525 with the value field 535 based on the condition field 530, a determination regarding whether a breach occurred is able to be made. Fields 525-535 define metrics for the SLA. In some embodiments, the fields 525-535 are completed in operation 106 (FIG. 1).

The above description of GUI 500 is not limiting as to the type of information and functionality of the GUI 500. One of ordinary skill in the art would recognize that the GUI 500 includes additional functionality that is not described in detail above. For example, in some embodiments, the GUI 500 includes a notification functionality to receive a notification in in response to acceptable or modification to the SLA template.

FIG. 6 is a view of a GUI 600 for creating an SLA in accordance with some embodiments. The GUI 600 is usable as to help create SLA templates by receiving information to be input into the SLA. In some embodiments, the GUI 600 is generated based on receiving of template entries, e.g., in operation 106 (FIG. 1), in operation 108 (FIG. 1), in response to receiving or creating an SLA template. In some embodiments, the GUI 600 is usable by a system, e.g., system 300 (FIG. 3), system 700 (FIG. 7), or another suitable system in order to assist with creation of SLAs. In some embodiments, the GUI 600 is generated to receive information from a user, e.g., based on information received in operation 106 (FIG. 1) and/or operation 108 (FIG. 1). Some of the fields in GUI 600 are already described above with respect to GUI 500 (FIG. 5). Description of these fields will be omitted for the sake of brevity.

The GUI 600 includes a breach time field 605 that indicates a numerical value for when a breach is determined to occur. The GUI 600 further includes a unit field 610 that indicates a unit for the numerical value, e.g., minutes, days, weeks, etc. In some embodiments, the unit field 610 includes a drop down menu for selectable options. The GUI 600 further includes an action field 615 that indicates what action should be take in response to determining that a breach has occurred. In some embodiments, the action includes sending a notification, such as in operation 222 (FIG. 2). In some embodiments, the action includes other options such as automatic implementing of a remedy defined by the SLA.

The GUI 600 further includes a timing field 620 configured to receive information for when the action is to be performed in response to a detected breach. For example, in some embodiments, the timing field 620 indicates that the action should be performed “on time” meaning at the time of the breach. In some embodiments, a recipient of a notification wishes to avoid multiple notifications of breaches throughout a day. In order to reduce a risk of overwhelming the recipient with breach notifications, the timing field 620 includes options such as a following morning or a following Monday (or other day of the week) after the breach occurred. By grouping breach notifications to be all at a same time, a recipient's daily work is less likely to be interrupted by numerous notifications throughout the day in a situation where the recipient receives information from numerous SLAs. In some embodiments, the timing field 620 provides a drop down menu with selection options.

The GUI 600 further includes a notification template field 625. The notification template field 625 allows selectin of a content of a breach notification, such as time of the notification, information on potential remedies, etc. In some embodiments, additional notification templates are able to be added to the notification template field 625. In some embodiments, the notification template field includes a drop down menu of selectable options.

The GUI 600 further includes a recipient field 630 for receiving information for an identity of a recipient of the breach notification. In some embodiments, the recipient field 630 includes a drop down menu of selectable options. In some embodiments, additional identities of potential recipients are includable in the recipient field 630. The GUI 600 further includes contact information field 635. The contact information field 635 includes information for contacting the recipient defined in the recipient field 630. For example, in some embodiments, the contact information field 635 includes an email address, a phone number, a user name/ID on a desired system, or other suitable contact information.

The above description of GUI 600 is not limiting as to the type of information and functionality of the GUI 600. One of ordinary skill in the art would recognize that the GUI 600 includes additional functionality that is not described in detail above. For example, in some embodiments, the GUI 600 includes an ability to receive custom information from the user instead of selecting options from drop down menus.

FIG. 7 is a block diagram of a system 700 for creating or managing an SLA in accordance with some embodiments. System 700 includes a hardware processor 702 and a non-transitory, computer readable storage medium 704 encoded with, i.e., storing, the computer program code 706, i.e., a set of executable instructions. Computer readable storage medium 704 is also encoded with instructions 707 for interfacing with external devices. The processor 702 is electrically coupled to the computer readable storage medium 704 via a bus 708. The processor 702 is also electrically coupled to an I/O interface 710 by bus 708. A network interface 712 is also electrically connected to the processor 702 via bus 708. Network interface 712 is connected to a network 714, so that processor 702 and computer readable storage medium 704 are capable of connecting to external elements via network 714. The processor 702 is configured to execute the computer program code 706 encoded in the computer readable storage medium 704 in order to cause system 700 to be usable for performing a portion or all of the operations as described in method 100 (FIG. 1) or method 200 (FIG. 2).

In some embodiments, the processor 702 is a central processing unit (CPU), a multi-processor, a distributed processing system, an application specific integrated circuit (ASIC), and/or a suitable processing unit.

In some embodiments, the computer readable storage medium 704 is an electronic, magnetic, optical, electromagnetic, infrared, and/or a semiconductor system (or apparatus or device). For example, the computer readable storage medium 704 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 704 includes a compact disk-read only memory (CD-ROM), a compact disk-read/write (CD-R/W), and/or a digital video disc (DVD).

In some embodiments, the storage medium 704 stores the computer program code 706 configured to cause system 700 to perform a portion or all of the operations as described in method 100 (FIG. 1) or method 200 (FIG. 2). In some embodiments, the storage medium 704 also stores information needed for performing a portion or all of the operations as described in method 100 (FIG. 1) or method 200 (FIG. 2) as well as information generated during performing a portion or all of the operations as described in method 100 (FIG. 1) or method 200 (FIG. 2), such as a template parameter 716, a SLA ID parameter 718, a breach metrics parameter 720, a notification parameter 722, and/or a set of executable instructions to perform the operation of a portion or all of the operations as described in method 100 (FIG. 1) or method 200 (FIG. 2).

In some embodiments, the storage medium 704 stores instructions 707 for interfacing with external devices. The instructions 707 enable processor 702 to generate instructions readable by the external devices to effectively implement a portion or all of the operations as described in method 100 (FIG. 1) or method 200 (FIG. 2).

System 700 includes I/O interface 710. I/O interface 710 is coupled to external circuitry. In some embodiments, I/O interface 710 includes a keyboard, keypad, mouse, trackball, trackpad, and/or cursor direction keys for communicating information and commands to processor 702.

System 700 also includes network interface 712 coupled to the processor 702. Network interface 712 allows system 700 to communicate with network 714, to which one or more other computer systems are connected. Network interface 712 includes wireless network interfaces such as BLUETOOTH, WIFI, WIMAX, GPRS, or WCDMA; or wired network interface such as ETHERNET, USB, or IEEE-1394. In some embodiments, a portion or all of the operations as described in method 100 (FIG. 1) or method 200 (FIG. 2) is implemented in two or more systems 700, and information such as template parameter 716, SLA ID parameter 718, breach metrics parameter 720 and notification parameter 722 are exchanged between different systems 700 via network 714.

An aspect of this description relates to a system for managing a service level agreement (SLA). The system includes a non-transitory computer readable medium configured to store instructions thereon. The system further includes a processor connected to the non-transitory computer readable medium. The processor is configured to execute the instructions for searching a database containing a plurality of SLA records thereon, wherein searching the database comprises searching the database based on a query. The processor is further configured to execute the instructions for identifying, in response to a determination that at least one SLA of the plurality of SLA records matches the query, actions to be taken, wherein each of the actions is defined by the at least one SLA. The processor is further configured to execute the instructions for determining whether a breach of the at least one SLA occurred based on the identified actions to be taken. The processor is further configured to execute the instructions for instructing a transmitter to automatically transmit a breach notification to a recipient in response to a determination that a breach of the least one SLA occurred, wherein the recipient is defined by the at least one SLA. In some embodiments, the processor is further configured to execute the instructions for automatically creating the query. In some embodiments, the processor is further configured to execute the instructions for receiving the query from an external device. In some embodiments, the processor is further configured to execute the instructions for instructing the transmitter to automatically transmit the notification to a mobile device controllable by the recipient via wirelessly, and the notification is configured to generate an alert on the mobile device. In some embodiments, the processor is configured to execute the instructions for generating a graphical user interface (GUI) in response to the determination that the at least one SLA matches the query; and instructing a display to display the GUI including identifying information for the at least one SLA. In some embodiments, the processor is further configured to execute the instructions for generating the GUI including information related to a type of action item which triggered the match with the query. In some embodiments, the processor is further configured to execute the instructions for updating an SLA execution table in response to the determination that the breach of the least one SLA occurred. In some embodiments, the processor is further configured to execute the instructions for generating an alert in response to a determination that none of the plurality of SLA records match the query. In some embodiments, the processor is further configured to execute the instructions for searching the database based on a second query in response to a determination that no breach of the at least one SLA has occurred. In some embodiments, the processor is further configured to execute the instructions for instructing the transmitter to provide the recipient with at least one remedy option along with the breach notification. In some embodiments, the processor is further configured to execute the instructions for instructing the transmitter to automatically transmit the breach notification at a timing defined by the at least one SLA.

An aspect of this description relates to a method of managing a service level agreement (SLA). The method includes searching a database containing a plurality of SLA records thereon, wherein searching the database comprises searching the database based on a query. The method further includes identifying, in response to a determination that at least one SLA of the plurality of SLA records matches the query, actions to be taken, wherein each of the actions is defined by the at least one SLA. The method further includes determining whether a breach of the at least one SLA occurred based on the identified actions to be taken. The method further includes automatically transmitting a breach notification to a recipient in response to a determination that a breach of the least one SLA occurred, wherein the recipient is defined by the at least one SLA. In some embodiments, the method further includes automatically creating the query. In some embodiments, the method further includes receiving the query from an external device. In some embodiments, the method further includes automatically transmitting the notification to a mobile device controllable by the recipient via wirelessly, and the notification is configured to generate an alert on the mobile device. In some embodiments, the method further includes generating a graphical user interface (GUI) in response to the determination that the at least one SLA matches the query; and instructing a display to display the GUI including identifying information for the at least one SLA. In some embodiments, the method further includes providing the recipient with at least one remedy option along with the breach notification. In some embodiments, automatically transmitting the breach notification includes automatically transmitting the breach notification at a timing defined by the at least one SLA.

An aspect of this description relates to a non-transitory computer readable medium storing instructions thereon. The instructions are executable by a processor to cause the processor to search a database containing a plurality of SLA records thereon, wherein searching the database comprises searching the database based on a query. The instructions are further configured to cause the processor to identify, in response to a determination that at least one SLA of the plurality of SLA records matches the query, actions to be taken, wherein each of the actions is defined by the at least one SLA. The instructions are further configured to cause the processor to determine whether a breach of the at least one SLA occurred based on the identified actions to be taken. The instructions are further configured to cause the processor to instruct a transmitter to automatically transmit a breach notification to a recipient in response to a determination that a breach of the least one SLA occurred, wherein the recipient is defined by the at least one SLA. In some embodiments, the instructions are further configured to cause the processor to instruct the transmitter to automatically transmit the notification to a mobile device controllable by the recipient via wirelessly, wherein the notification is configured to generate an alert on the mobile device.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system for managing a service level agreement (SLA), the system comprises:
a non-transitory computer readable medium configured to store instructions thereon; and
a processor connected to the non-transitory computer readable medium, wherein the processor is configured to execute the instructions for:
searching a database containing a plurality of SLA records thereon, wherein searching the database comprises searching the database based on a query;
identifying, in response to a determination that at least one SLA of the plurality of SLA records matches the query, actions to be taken, wherein each of the actions is defined by the at least one SLA;
determining whether a breach of the at least one SLA occurred based on the identified actions to be taken; and
instructing a transmitter to automatically transmit a breach notification to a recipient in response to the determination that the breach of the least one SLA occurred, wherein the recipient is defined by the at least one SLA.

2. The system of claim 1, wherein the processor is further configured to execute the instructions for automatically creating the query.

3. The system of claim 1, wherein the processor is further configured to execute the instructions for receiving the query from an external device.

4. The system of claim 1, wherein the processor is further configured to execute the instructions for instructing the transmitter to automatically transmit the notification to a mobile device controllable by the recipient via wirelessly, and the notification is configured to generate an alert on the mobile device.

5. The system of claim 1, wherein the processor is configured to execute the instructions for:
generating a graphical user interface (GUI) in response to the determination that the at least one SLA matches the query; and
instructing a display to display the GUI including identifying information for the at least one SLA.

6. The system of claim 5, wherein the processor is further configured to execute the instructions for generating the GUI including information related to a type of action item which triggered the match with the query.

7. The system of claim 1, wherein the processor is further configured to execute the instructions for updating an SLA execution table in response to the determination that the breach of the least one SLA occurred.

8. The system of claim 1, wherein the processor is further configured to execute the instructions for generating an alert in response to a determination that none of the plurality of SLA records match the query.

9. The system of claim 1, wherein the processor is further configured to execute the instructions for searching the database based on a second query in response to a determination that no breach of the at least one SLA has occurred.

10. The system of claim 1, wherein the processor is further configured to execute the instructions for instructing the transmitter to provide the recipient with at least one remedy option along with the breach notification.

11. The system of claim 1, wherein the processor is further configured to execute the instructions for instructing the transmitter to automatically transmit the breach notification at a timing defined by the at least one SLA.

12. A method of managing a service level agreement (SLA), wherein the method comprises:
searching a database containing a plurality of SLA records thereon, wherein searching the database comprises searching the database based on a query;
identifying, in response to a determination that at least one SLA of the plurality of SLA records matches the query, actions to be taken, wherein each of the actions is defined by the at least one SLA;
determining, using at least one processor, whether a breach of the at least one SLA occurred based on the identified actions to be taken; and
automatically transmitting a breach notification to a recipient in response to the determination that the breach of the least one SLA occurred, wherein the recipient is defined by the at least one SLA.

13. The method of claim 12, further comprising automatically creating the query.

14. The method of claim 12, further comprising receiving the query from an external device.

15. The method of claim 12, further comprising automatically transmitting the notification to a mobile device controllable by the recipient via wirelessly, and the notification is configured to generate an alert on the mobile device.

16. The method of claim 12, further comprising:
generating a graphical user interface (GUI) in response to the determination that the at least one SLA matches the query; and
instructing a display to display the GUI including identifying information for the at least one SLA.

17. The method of claim 12, further comprising providing the recipient with at least one remedy option along with the breach notification.

18. The method of claim 12, wherein automatically transmitting the breach notification comprises automatically transmitting the breach notification at a timing defined by the at least one SLA.

19. A non-transitory computer readable medium storing instructions thereon, wherein the instructions are executable by a processor to cause the processor to:
search a database containing a plurality of SLA records thereon, wherein searching the database comprises searching the database based on a query;
identify, in response to a determination that at least one SLA of the plurality of SLA records matches the query, actions to be taken, wherein each of the actions is defined by the at least one SLA;
determine whether a breach of the at least one SLA occurred based on the identified actions to be taken; and
instruct a transmitter to automatically transmit a breach notification to a recipient in response to the determination that the breach of the least one SLA occurred, wherein the recipient is defined by the at least one SLA.

20. The non-transitory computer readable medium of claim 19, wherein the instructions are further configured to cause the processor to instruct the transmitter to automatically transmit the notification to a mobile device controllable by the recipient via wirelessly, wherein the notification is configured to generate an alert on the mobile device.
